(19) United States
(12) Patent Application Publication
(10) Pub. No.: US 2026/0317207 A1
(43) Pub. Date: Oct. 15, 2026

(54) SYSTEMS AND METHODS FOR ENERGY RECOVERY FROM ELECTROCHEMICAL SEAWATER MINERALIZATION

(71) Applicants: The Regents of the University of California, Oakland, CA (US); Equatic, Inc., Santa Monica, CA (US)

(72) Inventors: Gaurav N. Sant, Los Angeles, CA (US); Lorenzo Corsini, Santa Monica, CA (US); David Jassby, Los Angeles, CA (US); Thomas J. Traynor, Los Angeles, CA (US)

(21) Appl. No.: 19/466,895

(22) Filed: Feb. 2, 2026

Related U.S. Application Data
(60) Provisional application No. 63/752,115, filed on Jan. 31, 2025.

(51) Int. Cl. C02F 1/461; C02F 101/10; C02F 103/08; C25B 1/04; C25B 1/26; C25B 9/23; C25B 15/08; H01M 8/0656

(52) U.S. Cl. CPC C02F 1/4618; C25B 1/04; C25B 1/26; C25B 9/23; C25B 15/087; H01M 8/0656; C02F 2001/4619; C02F 2101/10; C02F 2103/08; C02F 2201/46115; C02F 2201/46185

(57) ABSTRACT

The present disclosure relates to systems and methods for alkalinizing solutions comprising chloride ions.

### CROSS-REFERENCE TO RELATED APPLICATIONS

This application claims the benefit of priority to U.S. Provisional Application No. 63/752,115, filed Jan. 31, 2025, the contents of which are herein incorporated by reference in their entirety.

### BACKGROUND

The process of electrochemical saline water alkalinization (i.e., increasing the pH of the saline water) harnesses the unique attributes of seawater for efficient CO₂ removal. By leveraging the ocean-atmosphere equilibrium of CO₂ and the abundant divalent alkaline earth cations in seawater (55 mM Mg²⁺ and 10.5 mM Ca²⁺), the electrochemical formation of carbonate and hydroxide minerals such as Ca-, Mg-carbonates and hydroxides can be achieved. The aforementioned minerals not only immobilize dissolved CO₂ but also capture additional atmospheric CO₂ as carbonates and bicarbonates. The electrochemical transformation (converting CO₂ to carbonates using alkaline earth hydroxides) occurs without the need for costly chemical additives like NaOH, utilizing instead the pH swing induced by the electrolytic process near electrode surfaces to generate hydroxide ions (OH) that aid in the nucleation and growth of the mineral precipitates.

A typical challenge in saline water electrolysis is the anodic oxidation of chloride ions, leading to the generation of potentially harmful chlorine species (Cl₂, ClO⁻, HClO). Accordingly, there exists a need for electrochemical methods of alkalinizing aqueous solutions that allow for safe and efficient use of cathodic and/or anodic gas products.

### SUMMARY OF THE INVENTION

In certain aspects, provided herein are systems for alkalinizing an aqueous solution comprising:
an electrochemical cell comprising:
   a cathodic chamber comprising:
      a cathode;
      a catholyte feed inlet;
      a cathodic gas outlet; and
      a cathode product outlet;
   an anodic chamber comprising:
      an anode;
      an anolyte feed inlet;
      an anodic gas outlet; and
      an anode product outlet; and
   a separator membrane disposed between the cathodic chamber and the anodic chamber;
wherein the cathodic chamber and the anodic chamber are in ionic communication; and
further wherein:
   the cathodic chamber comprises a cathodic gas inlet coupled to the cathodic gas outlet; or
   the anodic chamber comprises an anodic gas inlet coupled to the anodic gas outlet; or
   the cathodic chamber comprises a cathodic gas inlet coupled to the cathodic gas outlet and the anodic chamber comprises an anodic gas inlet coupled to the anodic gas outlet.

In other aspects, provided herein are systems for alkalinizing an aqueous solution comprising:
an electrochemical cell comprising:
   a first cathodic chamber comprising:
      a first cathode;
      a catholyte feed inlet;
      a cathodic gas outlet;
      a first cathode product outlet;
   a first anodic chamber comprising:
      a first anode;
      an anolyte feed inlet;
      an anodic gas outlet;
      a first anode product outlet; and
   a separator membrane disposed between the first cathodic chamber and the first anodic chamber; and
a fuel cell comprising:
   a second cathodic chamber comprising:
      a second cathode
      an oxidant inlet coupled to the anodic gas outlet of the first anodic chamber;
      a second cathode product outlet;
   a second anodic chamber comprising:
      a second anode;
      a fuel inlet coupled to the cathodic gas outlet of the first cathodic chamber;
      a second anode product outlet; and
   an electrolyte material disposed between and in contact with the second cathode and the second anode;
wherein:
the cathodic gas outlet is coupled to the cathodic gas inlet;
the anodic gas outlet is coupled to the anodic gas inlet;
the second anode and second cathode are electrically connected; and
the second cathodic chamber and the second anodic chamber are in ionic communication.

In certain embodiments, provided herein are methods of alkalinizing solutions comprising: contacting:
a catholyte feed inlet of an electrochemical cell with a catholyte feed comprising water; and
an anolyte feed inlet of the electrochemical cell with an anolyte feed comprising chloride;
wherein the electrochemical cell comprises:
   a cathodic chamber comprising:
      a cathode;
      the catholyte feed inlet;
      a cathodic gas outlet; and
      a cathode product outlet;
   an anodic chamber comprising:
      an anode;
      the anolyte feed inlet;
      an anodic gas outlet; and
      an anode product outlet; and
   a separator membrane disposed between the cathodic chamber and the anodic chamber;
wherein:
   the cathodic chamber and the anodic chamber are in ionic communication; and
further wherein:
   the cathodic chamber comprises a cathodic gas inlet coupled to the cathodic gas outlet; or
   the anodic chamber comprises an anodic gas inlet coupled to the anodic gas outlet; or
   the cathodic chamber comprises a cathodic gas inlet coupled to the cathodic gas outlet and the anodic chamber comprises an anodic gas inlet coupled to the anodic gas outlet
applying a voltage across the anode and the cathode, thereby converting chloride to chlorine in the anodic chamber and converting water to hydrogen and hydroxide in the cathodic chamber.

In other aspects, provided herein are methods of alkalinizing aqueous solutions comprising: contacting:
a catholyte feed inlet of an electrochemical cell with a catholyte feed comprising water; and
an anolyte feed inlet of the electrochemical cell with an anolyte feed comprising chloride;
wherein the electrochemical cell comprises:
   a first cathodic chamber comprising:
      a first cathode;
      the catholyte feed inlet;
      a cathodic gas outlet; and
      a first cathode product outlet;
   an anodic chamber comprising:
      a first anode;
      the anolyte feed inlet;
      an anodic gas outlet; and
      a first anode product outlet; and
   a first membrane disposed between the first cathodic chamber and the first anodic chamber;
   wherein the first cathodic chamber and the first anodic chamber are in ionic communication;
applying a voltage across the first anode and the first cathode, thereby converting chloride to chlorine in the first anodic chamber and converting water to hydrogen and hydroxide in the first cathodic chamber;
transferring the chlorine to an oxidant inlet of a fuel cell and the hydrogen to a fuel inlet of the fuel cell;
   wherein the fuel cell further comprises:
      a second cathodic chamber comprising:
         a second cathode
         an oxidant inlet coupled to the anodic gas outlet of the first anodic chamber;
         a second cathode product outlet;
      a second anodic chamber comprising:
         the second anode;
         a fuel inlet coupled to the cathodic gas outlet of the first cathodic chamber;
         a second anode product outlet; and
      an electrolyte material disposed between and in contact with the second cathode and the second anode;
   and wherein the second anode and second cathode are electrically connected through a circuit, and the second cathodic chamber and the second anodic chamber are in ionic communication; and
converting the hydrogen to protons (H⁺) and electrons and converting chlorine to chloride, thereby generating an electric current from the second anode to the second cathode.

### BRIEF DESCRIPTION OF THE DRAWINGS

FIG. 1 is a diagram of a process according to certain embodiments of the present disclosure, as described in Example 1.

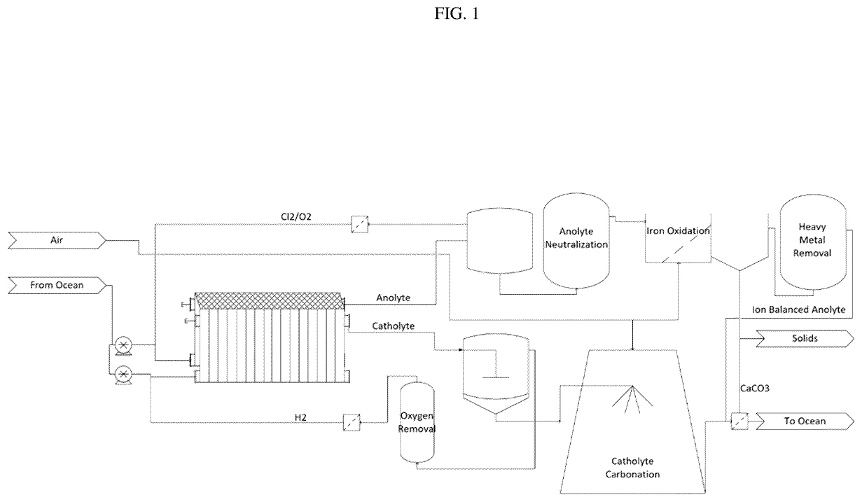

FIG. 2 is a diagram of a process according to certain embodiments of the present disclosure, as described in Example 2.

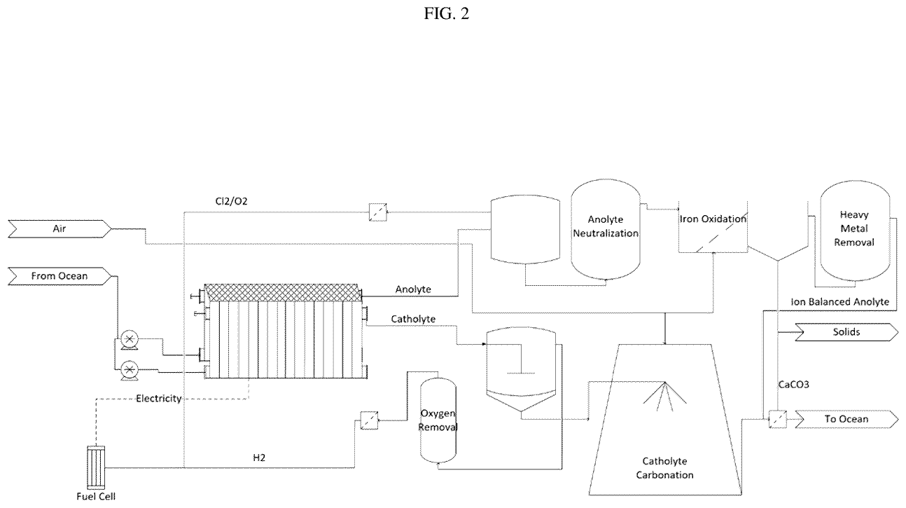

### DETAILED DESCRIPTION OF THE INVENTION

Electrolysis of solutions comprising chloride (e.g., seawater electrolysis) is a highly desirable means of generating alkaline solutions (e.g., solutions comprising hydroxide species) suitable for carbon dioxide capture. However, such processes, to be industrially viable, must address the challenge involving generation of free chlorine species at the anode during the electrolysis. In certain aspects, provided herein are systems and methods for alkalinizing solutions which comprise recycling the gas generated by the electrolyzer at the anode (the anodic gas), the gas generated at the cathode (the cathodic gas), or both.

In certain embodiments, the systems and methods of the present disclosure involve recycling product gases back to the anode and cathode. In other embodiments, systems and methods of the present disclosure involve routing the product gases to an external fuel cell to generate electricity that can be used, e.g., to charge a battery and/or to power the electrolyzer.

In certain embodiments, recycling of product gases refers to returning a gas to the electrochemical cell to participate in electrochemical reactions, whereas recovery refers to removal of a gas from the electrochemical cell boundary for energy generation, storage, or export. In certain embodiments, hydrogen generated at the cathode is recovered for energy use without being recycled to the electrochemical cell. In such embodiments, anodically generated chlorine may be recycled, neutralized, vented, absorbed, or otherwise treated without participating in energy recovery.

During electrolysis, hydrogen gas (H₂) is produced at the cathode as a byproduct of the water-splitting reaction. This hydrogen can be recycled back to the cathode and re-oxidized to protons (H⁺). Alternatively, the hydrogen may be diverted from the cathodic gas outlet to an external energy recovery system, storage vessel, or downstream process without reintroduction to the electrochemical cell. In such embodiments, hydrogen is effectively a reactant, which could reduce the need for additional energy input to sustain the electrochemical reaction. Without wishing to be bound by theory, the recycled hydrogen may undergo the reverse reaction of hydrogen evolution, as shown in Equation I:

$${H}_{2} \to 2 {H}^{+} + 2 {e}^{-} \qquad ( I )$$

On the anode side, chlorine gas (Cl₂) is generated from the oxidation of chloride ions in seawater. This chlorine gas can be recycled to the anode. The recycled chlorine provides a supply of electrons to the anode, potentially reducing the energy required to sustain oxidation reactions. Without wishing to be bound by theory, the recycled chlorine may be reduced back into chloride, as shown in Equation II:

$${Cl}_{2} \to 2 {Cl}^{-} + 2 {e}^{-} \qquad ( II )$$

The standard potential (E°) for chlorine evolution is about +1.36 V vs. SHE.

The typical Voltage (with no gas recycling) is ~2.8-3.2 V at 300 A/m², which means that with Hydrogen and Chlorine Recycling, the operating voltage could be reduced, potentially approaching values in the range of 1.5V to 2 V, depending on other factors affecting efficiency. While not bound by theory, this may be because both half-reactions (hydrogen oxidation and chlorine reduction) require significantly less energy than their water-splitting and chloride oxidation counterparts.

Reduction in operating voltage and energy recovery from hydrogen are independent aspects of the disclosed systems. Hydrogen recovery for energy generation may be practiced regardless of whether recycled gases are used to reduce cell voltage and whether a net energy offset is achieved.

In certain embodiments, provided herein are systems where chlorine gas generated at the anode is recycled back to the anode during electrolysis. In some such embodiments, the anode can preferably function simultaneously as a positive electrode and a negative electrode. This dual functionality is achieved through careful control of the electrochemical environment and system design, as will be understood by one of ordinary skill in the art. During electrolysis, the anode facilitates the oxidation of chloride ions (Cl⁻) into chlorine gas (Cl₂), releasing electrons into the circuit. When the chlorine gas is fed back to the anode, it can undergo a reduction reaction, converting Cl₂ back into Cl⁻ ions while accepting electrons, analogous to how a cathode operates in a fuel cell. These two reactions can occur simultaneously across the anode, or in distinct regions of the anode, based on the localized potential and gas concentration.

In certain embodiments, configurations involving recycling of the anodic gas and/or the cathodic gas involves precise management of the applied potential to allow both reactions to occur efficiently. The recycling of chlorine reduces the potential necessary for further oxidation to occur, lowering the overall cell voltage requirements and improving system efficiency. Additionally, the energy released from the chlorine reduction reaction can be harnessed to offset the energy input for electrolysis. One of ordinary skill in the art will, using their general background knowledge of electrolysis systems, be able to determine and maintain the appropriate applied potentials for any specific embodiment of the presently disclosed systems. Specialized anode materials, often noble metal-based, enable the electrode to catalyze both oxidation and reduction reactions without degradation. A membrane or other suitable type of separator allows the physical separation of gases and ions, preventing cross-contamination while maintaining ion flow. The integration of product gas reduction at the electrodes enhances energy recovery and minimizes the operational costs and potential environmental impacts of chlorine and hydrogen gas handling.

Gas separation and purification may be performed on the cathodic gas and anodic gas before recycling the hydrogen and chlorine gases into the electrolyzer to reduce contamination or unintended side reactions, and the electrodes should be designed to withstand the recycling process and facilitate efficient reoxidation and reduction of the recycled gases.

In certain embodiments, purification and conditioning of hydrogen are performed to meet the requirements of downstream energy utilization systems rather than for recycling to the electrochemical cell.

In certain aspects, provided herein are systems for alkalinizing an aqueous solution comprising:
an electrochemical cell comprising:
   a cathodic chamber comprising:
      a cathode;
      a catholyte feed inlet;
      a cathodic gas outlet; and
      a cathode product outlet;
   an anodic chamber comprising:
      an anode;
      an anolyte feed inlet;
      an anodic gas outlet; and
      an anode product outlet; and
a separator membrane disposed between the cathodic chamber and the anodic chamber;
wherein the cathodic chamber and the anodic chamber are in ionic communication; and
further wherein:
   the cathodic chamber comprises a cathodic gas inlet coupled to the cathodic gas outlet; or
   the anodic chamber comprises an anodic gas inlet coupled to the anodic gas outlet; or
   the cathodic chamber comprises a cathodic gas inlet coupled to the cathodic gas outlet and the anodic chamber comprises an anodic gas inlet coupled to the anodic gas outlet.

In certain embodiments, the cathodic chamber comprises a cathodic gas inlet coupled to the cathodic gas outlet. In certain embodiments, the anodic chamber comprises an anodic gas inlet coupled to the anodic gas outlet. In other embodiments, the cathodic chamber comprises a cathodic gas inlet coupled to the cathodic gas outlet; and the anodic chamber further comprises an anodic gas inlet, and the anodic gas outlet is coupled to the anodic gas inlet.

In certain embodiments, the cathodic chamber further comprises a carbon dioxide inlet. In certain embodiments, the system further comprises a carbonation chamber comprising: a carbon dioxide inlet; an alkalinized product inlet coupled to the alkalinized product outlet; and a carbonated product outlet; and wherein the cathodic chamber is configured to capture carbon dioxide from a fluid comprising carbon dioxide. In some embodiments, the fluid is a gas. In other embodiments, the fluid is a liquid.

In certain embodiments, the system further comprises an anodic gas separator coupled to the anodic gas outlet. In certain embodiments, the system further comprises a cathodic gas separator coupled to the cathodic gas outlet.

In certain embodiments, the system further comprises a cathodic gas recycling system, comprising: a cathodic gas recycling inlet coupled to the cathodic gas outlet of the cathodic chamber; a cathodic gas recycling outlet coupled to the cathodic gas inlet of the cathodic chamber; and a compressor configured to increase a pressure of a fluid; and wherein the cathodic gas recycling system is configured to transfer a cathodic gas from the cathodic gas outlet to the cathodic gas inlet.

In certain embodiments, the system further comprises an anodic gas recycling system, comprising: an anodic gas recycling inlet coupled to the cathodic gas outlet of the anodic chamber; an anodic gas recycling outlet coupled to the anodic gas inlet of the anodic chamber; and a compressor configured to increase a pressure of a gaseous fluid; and wherein the anodic gas recycling system is configured to transfer an anodic gas from the anodic gas outlet to the anodic gas inlet.

In other embodiments, the system further comprises a combined gas recycling system comprising: a cathodic gas recycling system, comprising: a cathodic gas recycling inlet coupled to the cathodic gas outlet of the cathodic chamber; a cathodic gas recycling outlet coupled to the cathodic gas inlet of the cathodic chamber; and a compressor configured to increase a pressure of a fluid; and wherein the cathodic gas recycling system is configured to transfer a cathodic gas from the cathodic gas outlet to the cathodic gas inlet; and an anodic gas recycling system, comprising: an anodic gas recycling inlet coupled to the cathodic gas outlet of the anodic chamber; an anodic gas recycling outlet coupled to the anodic gas inlet of the anodic chamber; and a compressor configured to increase a pressure of a gaseous fluid; and wherein the anodic gas recycling system is configured to transfer an anodic gas from the anodic gas outlet to the anodic gas inlet.

In certain embodiments, the anode is configured to convert chloride to chlorine. In further embodiments, when a voltage is applied to the anode and the anode is contacted with an aqueous solution comprising chloride, Cl₂ and H⁺ and/or H₃O⁺ ions are produced selectively at the anode.

In certain embodiments, the cathode is configured to convert water to hydroxide ions and hydrogen. In certain embodiments, the cathode is configured to convert protons to hydrogen. In further embodiments, when a voltage is applied to the cathode and the cathode is contacted with water, H₂ and OH⁻ ions are produced selectively at the cathode.

In certain embodiments, the cathodic gas recycling inlet and the anodic gas recycling inlet comprise backflow prevention valves (e.g., backflow preventers or gas non-return valves).

In certain embodiments, the electrochemical cell is configured to operate at an electrical potential of 1 ss than about 2.8 V at a current density of about 300 A/m². In further embodiments, the electrochemical cell is configured to operate at an electrical potential of less than about 2.5 V at a current density of about 300 A/m². In yet further embodiments, the electrochemical cell is configured to operate at an electrical potential of less than about 2.0 V at a current density of about 300 A/m². In yet further embodiments, the electrochemical cell is configured to operate at an electrical potential of from about 1.5 V to about 2 V at a current density of about 300 A/m². In preferred embodiments, the electrochemical cell is configured to operate at an electric potential of from about 1.2 V to about 4 V at a current density of about 300 A/m². In certain embodiments, the system comprises a plurality of electrochemical cells (e.g., in a unit cell arrangement). In certain embodiments, the plurality of electrochemical cells is arranged in a stack (e.g., a stacked unit cell). In certain embodiments, an electrochemical unit cell is configured to operate at an electrical potential of less than about 2.8 V at a current density of about 300 A/m². In further embodiments, an electrochemical unit cell is configured to operate at an electrical potential of less than about 2.5 V at a current density of about 300 A/m². In yet further embodiments, an electrochemical unit cell is configured to operate at an electrical potential of less than about 2.0 V at a current density of about 300 A/m². In yet further embodiments, an electrochemical unit cell is configured to operate at an electrical potential of from about 1.5 V to about 2 V at a current density of about 300 A/m². In preferred embodiments, an electrochemical unit cell is configured to operate at an electric potential of from about 1.2 V to about 4 V at a current density of about 300 A/m². In certain embodiments, an electrochemical unit cell is configured to operate at a current density from about 10 A/m² to about 10,000 A/m². In further embodiments, an electrochemical unit cell is configured to operate at a current density from about 100 A/m² to about 1,000 A/m².

In certain embodiments, a method of alkalinizing aqueous solutions using any one of the systems described above comprises: contacting the catholyte feed inlet with a catholyte feed comprising water; contacting the anolyte feed inlet with an anolyte feed comprising chloride; and applying a voltage across the anode and the cathode, thereby converting chloride to chlorine in the anodic chamber and converting water to hydrogen and hydroxide in the cathodic chamber.

In other aspects, provided herein are systems for alkalinizing an aqueous solution comprising:
an electrochemical cell comprising:
   a first cathodic chamber comprising:
      a first cathode;
      a catholyte feed inlet;
      a cathodic gas outlet;
      a first cathode product outlet;
   a first anodic chamber comprising:
      a first anode;
      an anolyte feed inlet;
      an anodic gas outlet;
      a first anode product outlet; and
   a separator membrane disposed between the first cathodic chamber and the first anodic chamber; and
a fuel cell comprising:
   a second cathodic chamber comprising:
      a second cathode
      an oxidant inlet coupled to the anodic gas outlet of the first anodic chamber;
      a second cathode product outlet;
   a second anodic chamber comprising:
      a second anode;
      a fuel inlet coupled to the cathodic gas outlet of the first cathodic chamber;
      a second anode product outlet; and
   an electrolyte material disposed between and in contact with the second cathode and the second anode;
wherein:
the cathodic gas outlet is coupled to the cathodic gas inlet;
the anodic gas outlet is coupled to the anodic gas inlet;
the second anode and second cathode are electrically connected; and
the second cathodic chamber and the second anodic chamber are in ionic communication.

In certain embodiments, the second anode and second cathode are electrically connected to a battery. In certain alternative embodiments, the second anode and second cathode are electrically connected to a municipal power grid.

In certain embodiments, the first anode is configured to convert chloride to chlorine. In further embodiments, when a voltage is applied to the first anode and the first anode is contacted with an aqueous solution comprising chloride, Cl₂ and H⁺ and/or H₃O⁺ ions are produced selectively at the first anode.

In certain embodiments, the first cathode is configured to convert water to hydroxide ions and hydrogen.

In certain embodiments, the second anode is configured to convert hydrogen (H₂) to protons (H⁺) and electrons.

In certain embodiments, the fuel cell is configured to use hydrogen as a fuel and chlorine as an oxidant.

In certain embodiments, the fuel cell is a solid oxide fuel cell (SOFC).

In certain embodiments, the electrolyte material comprises a metal oxide, a ceramic, a ceramic-metal composite (cermet), or a combination thereof. In further embodiments, electrolyte material comprises a metal oxide. In yet further embodiments, the electrolyte material comprises a ceramic material. In yet further embodiments, the electrolyte material comprises a ceramic-metal composite (Cermet) material.

In certain embodiments, the fuel cell is a proton exchange membrane fuel cell (PEMFC).

In certain embodiments, the electrolyte material comprises a membrane. In certain preferred embodiments, the membrane is a proton exchange membrane.

In certain embodiments, the membrane is configured to allow the passage of H⁺ ions from the second cathode to the second anode.

In certain embodiments, the separator membrane comprises an anion exchange membrane. In other embodiments, the separator membrane comprises a cation exchange membrane. In yet other embodiments, the separator membrane is a bipolar membrane.

In certain embodiments, the separator membrane is configured to allow flow of ions and not allow flow of gases and electrons between the first anodic chamber and first cathodic chamber.

In certain embodiments, the catholyte feed inlet is coupled to a catholyte source. In certain other embodiments, the anolyte feed inlet is coupled to an anolyte source. In yet other embodiments, the catholyte source is the anolyte source.

In certain embodiments, a method of alkalinizing aqueous solutions using one of the systems described above comprises: contacting the catholyte feed inlet with a catholyte feed comprising water; contacting the anolyte feed inlet with an anolyte feed comprising chloride; and applying a voltage across the anode and the cathode, thereby converting chloride to chlorine in the first anodic chamber and converting water to hydrogen and hydroxide in the first cathodic chamber.

In certain embodiments, the system comprises a plurality of electrochemical cells (e.g., in a unit cell arrangement). In certain embodiments, the plurality of electrochemical cells is arranged in a stack (e.g., a stacked unit cell).

In certain embodiments, provided herein are methods of alkalinizing solutions comprising: contacting:
a catholyte feed inlet of an electrochemical cell with a catholyte feed comprising water; and
an anolyte feed inlet of the electrochemical cell with an anolyte feed comprising chloride;
wherein the electrochemical cell comprises:
   a cathodic chamber comprising:
      a cathode;
      the catholyte feed inlet;
      a cathodic gas outlet; and
      a cathode product outlet;
   an anodic chamber comprising:
      an anode;
      the anolyte feed inlet;
      an anodic gas outlet; and
      an anode product outlet; and
   a separator membrane disposed between the cathodic chamber and the anodic chamber;
wherein:
   the cathodic chamber and the anodic chamber are in ionic communication; and
further wherein:
   the cathodic chamber comprises a cathodic gas inlet coupled to the cathodic gas outlet; or
   the anodic chamber comprises an anodic gas inlet coupled to the anodic gas outlet; or
   the cathodic chamber comprises a cathodic gas inlet coupled to the cathodic gas outlet and the anodic chamber comprises an anodic gas inlet coupled to the anodic gas outlet
applying a voltage across the anode and the cathode, thereby converting chloride to chlorine in the anodic chamber and converting water to hydrogen and hydroxide in the cathodic chamber.

In certain embodiments, the cathodic chamber comprises a cathodic gas inlet coupled to the cathodic gas outlet. In certain embodiments, the anodic chamber comprises an anodic gas inlet coupled to the anodic gas outlet. In other embodiments, the cathodic chamber comprises a cathodic gas inlet coupled to the cathodic gas outlet and the anodic chamber further comprises an anodic gas inlet, and the anodic gas outlet is coupled to the anodic gas inlet.

In certain embodiments, the anodic chamber comprises an anodic gas inlet coupled to the anodic gas outlet and the method further comprises transferring the chlorine from the anodic gas outlet to the anodic gas inlet. In such embodiments, transferring the chlorine from the anodic gas outlet to the anodic gas inlet further comprises purifying the chlorine.

In certain embodiments, the method further comprises converting chlorine to chloride in the anodic chamber.

In certain embodiments, the cathodic chamber comprises a cathodic gas inlet coupled to the cathodic gas outlet, and the method further comprises transferring hydrogen from the cathodic gas outlet to the cathodic gas inlet. In such embodiments, transferring the hydrogen from the cathodic gas outlet to the cathodic gas inlet further comprises purifying the hydrogen.

In certain embodiments, the method further comprises converting hydrogen to protons in the cathodic chamber.

In certain embodiments, the method further comprises contacting carbon dioxide with the hydroxide, thereby generating a carbonation product comprising carbonate, bicarbonate, or a combination thereof. In further embodiments, contacting carbon dioxide with the hydroxide comprises generating carbonates. In further embodiments, contacting carbon dioxide with the hydroxide comprises generating bicarbonates. In yet further embodiments, contacting carbon dioxide with the hydroxide generates carbonates and bicarbonates. In yet further embodiments, the carbonation product further comprises magnesium, calcium, or a combination thereof.

In certain embodiments, wherein the anode is configured to convert chloride to chlorine. In certain further embodiments, when the voltage is applied to the anode and the anode is contacted with an aqueous solution comprising chloride, Cl₂ and H⁺ and/or H₃O⁺ ions are produced selectively at the anode.

In certain embodiments, the cathode is configured to convert water to hydroxide ions and hydrogen.

In certain embodiments, the cathode is configured to convert protons to hydrogen.

In certain embodiments, when the voltage is applied to the cathode and the cathode is contacted with water, H₂ and OH ions are produced selectively at the cathode. In certain embodiments, the voltage is less than about 2.8 V at a current density of about 300 A/m². In further embodiments, the voltage is less than about 2.5 V at a current density of about 300 A/m². In yet further embodiments, the voltage is less than about 2.0 V at a current density of about 300 A/m². In yet further embodiments, the voltage is from about 1.5 V to about 2 V at a current density of about 300 A/m².

In certain embodiments, the method comprises a plurality of electrochemical cells (e.g., in a unit cell arrangement). In certain embodiments, the plurality of electrochemical cells is arranged in a stack (e.g., a stacked unit cell). In certain embodiments, an electrochemical unit cell is configured to operate at an electrical potential of less than about 2.8 V at a current density of about 300 A/m². In further embodiments, an electrochemical unit cell is configured to operate at an electrical potential of less than about 2.5 V at a current density of about 300 A/m². In yet further embodiments, an electrochemical unit cell is configured to operate at an electrical potential of less than about 2.0 V at a current density of about 300 A/m². In yet further embodiments, an electrochemical unit cell is configured to operate at an electrical potential of from about 1.5 V to about 2 V at a current density of about 300 A/m². In preferred embodiments, an electrochemical unit cell is configured to operate at an electric potential of from about 1.2 V to about 4 V at a current density of about 300 A/m². In certain embodiments, an electrochemical unit cell is configured to operate at a current density from about 10 A/m² to about 10,000 A/m². In further embodiments, an electrochemical unit cell is configured to operate at a current density from about 100 A/m² to about 1,000 A/m².

In certain embodiments, the hydrogen generated at the cathode is recovered and supplied to an external energy utilization system. In further embodiments, the hydrogen generated at the cathode is recovered and supplied to an external energy utilization system in a separate step from any utilization, recycling, or conversion of chlorine generated during the method. In yet further embodiments, the hydrogen generated at any one of the cathodes is recovered and supplied to an external energy utilization system in a separate step from any utilization, recycling, or conversion of chlorine generated at the anode.

In certain embodiments, the method described is performed using the system of any one of the systems above.

In other aspects, provided herein are methods of alkalinizing aqueous solutions comprising: contacting:
a catholyte feed inlet of an electrochemical cell with a catholyte feed comprising water; and
an anolyte feed inlet of the electrochemical cell with an anolyte feed comprising chloride;
wherein the electrochemical cell comprises:
   a first cathodic chamber comprising:
      a first cathode;
      the catholyte feed inlet;
      a cathodic gas outlet; and
      a first cathode product outlet;
   an anodic chamber comprising:
      a first anode;
      the anolyte feed inlet;
      an anodic gas outlet; and
      a first anode product outlet; and
   a first membrane disposed between the first cathodic chamber and the first anodic chamber;
   wherein the first cathodic chamber and the first anodic chamber are in ionic communication;
applying a voltage across the first anode and the first cathode, thereby converting chloride to chlorine in the first anodic chamber and converting water to hydrogen and hydroxide in the first cathodic chamber;
transferring the chlorine to an oxidant inlet of a fuel cell and the hydrogen to a fuel inlet of the fuel cell;
   wherein the fuel cell further comprises:
      a second cathodic chamber comprising:
         a second cathode
         an oxidant inlet coupled to the anodic gas outlet of the first anodic chamber;
         a second cathode product outlet;
      a second anodic chamber comprising:
         the second anode;
         a fuel inlet coupled to the cathodic gas outlet of the first cathodic chamber;
         a second anode product outlet; and
      an electrolyte material disposed between and in contact with the second cathode and the second anode;
   and wherein the second anode and second cathode are electrically connected through a circuit, and the second cathodic chamber and the second anodic chamber are in ionic communication; and
converting the hydrogen to protons (H⁺) and electrons and converting chlorine to chloride, thereby generating an electric current from the second anode to the second cathode.

In certain embodiments, the method further comprises contacting carbon dioxide with the hydroxide, thereby generating a carbonation product comprising carbonate, bicarbonate, or a combination thereof. In further embodiments, contacting carbon dioxide with the hydroxide comprises generating carbonates. In yet further embodiments, contacting carbon dioxide with the hydroxide comprises generating bicarbonates. In yet further embodiments, contacting carbon dioxide with the hydroxide generates carbonates and bicarbonates. In yet further embodiments, the carbonation product further comprises magnesium, calcium, or a combination thereof.

In certain embodiments, when the voltage is applied to the first anode and the first anode is contacted with an aqueous solution comprising chloride, Cl₂ and H⁺ and/or H₃O⁺ ions are produced selectively at the first anode.

In certain embodiments, the anode is selective for chlorine evolution reactions over oxygen evolution reactions.

In certain embodiments, the cathode is configured to convert water to hydroxide ions and hydrogen.

In certain embodiments, the cathode is configured to convert protons to hydrogen.

In certain embodiments, when the voltage is applied to the first cathode and the first cathode is contacted with water, H₂ and OH⁻ ions are produced selectively at the first cathode. In certain embodiments, the second anode is configured to convert hydrogen (H₂) to protons (H⁺) and electrons.

In certain embodiments, the fuel cell is configured to consume hydrogen and chlorine (e.g., hydrogen as a fuel and chlorine as an oxidant).

In certain embodiments, the fuel cell is a solid oxide fuel cell (SOFC).

In certain embodiments, the electrolyte material comprises a metal oxide, a ceramic, a ceramic-metal composite (cermet), or a combination thereof. In further embodiments, the electrolyte material comprises a metal oxide. In yet further embodiments, the electrolyte material comprises a ceramic material. In yet further embodiments, the electrolyte material comprises a ceramic-metal composite (Cermet) material.

In certain embodiments, the fuel cell is a proton exchange membrane fuel cell (PEMFC).

In certain embodiments, the electrolyte material comprises a second membrane. In preferred embodiments, the second membrane is a proton exchange membrane.

In certain embodiments, the second membrane is configured to allow the passage of H⁺ ions from the second cathode to the second anode.

In certain embodiments, the first membrane comprises an anion exchange membrane. In certain embodiments, the first membrane comprises a cation exchange membrane. In other embodiments, the first membrane is a bipolar membrane.

In certain embodiments, the first membrane is configured to allow flow of ions and not allow flow of gases and electrons between the first anodic chamber and first cathodic chamber.

In certain embodiments, the hydrogen generated at the cathode is recovered and supplied to an external energy utilization system. In further embodiments, the hydrogen generated at the cathode is recovered and supplied to an external energy utilization system in a separate step from any utilization, recycling, or conversion of chlorine generated during the method. In yet further embodiments, the hydrogen generated at any one of the first cathode or second cathode is recovered and supplied to an external energy utilization system in a separate step from any utilization, recycling, or conversion of chlorine generated at the first anode or second anode. In certain embodiments, the method described is performed using one of the systems described above. In certain embodiments, a separator membrane separates the catholyte and the anolyte of the electrochemical cell in order to: (1) Prevent neutralization reactions from occurring between the catholyte and anolyte (i.e., by H⁺ ion crossover), thus maintaining distinct anode and cathode pH values; (2) Promote higher reactor energy efficiency; and (3) Facilitate the collection of gas streams (e.g., Cl₂ and H₂). In certain embodiments, the catholyte feed inlet is coupled to a catholyte source. In some embodiments, the anolyte feed inlet is coupled to an anolyte source. In certain embodiments, the catholyte source is the anolyte source. In certain preferred embodiments, the anolyte source and catholyte source is selected from seawater, desalination brine, industrial brine, and natural brine. In certain preferred embodiments, the anolyte source is seawater. In certain preferred embodiments, the catholyte source is seawater. In some preferred embodiments, the systems and methods provided herein alkalinize seawater. As will be understood by one of ordinary skill in the art, methods and systems provided herein may be particularly advantageous in alkalinizing seawater and/or brine solutions for the purpose of using the alkalinized seawater for carbon dioxide capture. For example, in certain embodiments, the systems and methods provided herein may use seawater and brine solutions in an electrolyzer without the need for additional chlorine treatment steps to dispose of chlorine generated at the anode.

In certain embodiments, systems of the present disclosure comprise additional components configured to collect and recycle the cathodic gas and/or the anodic gas. In such embodiments, the gas collection and handling components are suitable for efficiently capturing, purifying, and recycling hydrogen and/or chlorine gases. In some preferred embodiments, the gas collection is done at the gas-liquid separator, which, for example, may comprise corrosion-resistant materials like CPVC or PTFE.

In certain embodiments, methods of the disclosure comprise separating the anodic gas and/or the cathodic gas from the anode product and/or the cathode product, respectively. In some embodiments, systems of the disclosure further comprise an anodic gas separator coupled to the anodic gas outlet. In certain embodiments, systems of the disclosure further comprise a cathodic gas separator coupled to the cathodic gas outlet. In certain such embodiments, the anodic gas separator and the cathodic gas separator are preferably vessels suitable for allowing the anodic gas and/or the cathodic gas to disengage with the process fluid. One of ordinary skill in the art will understand how to design and/or select suitable separators for use in the systems and methods of the present disclosure, e.g., based on the solubility of the anodic gas and the cathodic gas in process fluids, and/or compatibility with other system components.

In some embodiments, once collected, the hydrogen and/or chlorine gases are passed through system components designed to prepare them for recycling back into the electrolyzer without the need for drying (e.g., removal of water vapor from the product gas mixture), which is not necessary given their immediate reuse in the electrolysis process. Hydrogen gas undergoes a deoxygenation process using a catalyst to convert any residual oxygen that might pose a risk of forming explosive mixtures. Both gases are filtered to remove any particulate matter that could impede their efficient reuse.

In certain embodiments, methods of the disclosure comprise pressurizing the cathodic gas and/or anodic gas. In some such embodiments, pressurization of the gases to the electrolyzer feed pressure is handled by compressors chosen explicitly for their compatibility with hydrogen and chlorine gases. In further embodiments, the compressors are constructed from materials capable of withstanding the properties of each gas (e.g., the corrosivity of chlorine gas and byproducts thereof), ensuring long-term reliability and safety.

The purified and pressurized gases are then routed back to their respective compartments in the electrolyzer through piping systems designed with safety and efficiency in mind. These systems include check valves and backflow preventers to ensure that gases do not mix or flow backward. Automated control valves can adjust the feed rates of recycled gases to optimize the electrolysis process.

The system may also incorporate comprehensive safety features, including gas concentration sensors for detecting leaks or crossover, pressure relief valves, and emergency venting systems designed to handle unexpected gas releases safely.

In the present disclosure, certain components of these systems are described as being “coupled” to one another. As will be appreciated, the term “coupled” as used herein describes components that are operationally linked to one another, but does not preclude the presence of intervening components between those said to be coupled to one another. In certain embodiments, components that are described as “coupled” to one another are in fluidic and/or gaseous communication. Additionally, as will be appreciated, various system components are described as “having” certain features. Such descriptions do not preclude, and specifically contemplate, the presence of additional features, such as inlets, outlets, valves, control mechanisms, measurement devices, heating and/or cooling systems, etc. Additionally, in the systems of the present disclosure, certain components are described as having one or more outlets or inlets. Such outlets and inlets may represent separate structural elements, or may be combined into a single inlet or outlet as suitable. The person of skill in the art will recognize that, once the important features and operating conditions of systems such as those described herein are understood, the detailed design and operation of such systems involved many choices, such as specific reagent flows, separation steps, etc. While the present disclosure provides a number of specific embodiments, any suitable combination of these design choices may be made.

In certain embodiments, the oxidant inlet, coupled to the anodic gas outlet of the first anodic chamber, further comprises a primary oxidant inlet and a secondary oxidant inlet, wherein the primary oxidant inlet is coupled to the anodic gas outlet of the first anodic chamber, and the secondary oxidant inlet is coupled to an external source of oxidant (e.g. an external source of Cl₂, such as an industrial waste stream from a process that produces Cl₂). In such embodiments, the external source of oxidant is not the electrochemical cell. One of ordinary skill in the art will understand how to configure the oxidant inlet such that the fuel cell receives a suitable amount of oxidant (e.g., Cl₂) from the anodic gas outlet and, when present, the external oxidant source.

### Definitions

Unless otherwise defined herein, scientific and technical terms used in this application shall have the meanings that are commonly understood by those of ordinary skill in the art. Generally, nomenclature used in connection with, and techniques of, chemistry, chemical engineering, electrical engineering and civil engineering described herein, are those well-known and commonly used in the art.

The methods and techniques of the present disclosure are generally performed, unless otherwise indicated, according to conventional methods well known in the art and as described in various general and more specific references that are cited and discussed throughout this specification.

Chemistry terms used herein, unless otherwise defined herein, are used according to conventional usage in the art, as exemplified by “The McGraw-Hill Dictionary of Chemical Terms”, Parker S., Ed., McGraw-Hill, San Francisco, C.A. (1985).

All publications, patents and published patent applications referred to in this application are specifically incorporated by reference herein. In case of conflict, the present specification, including its specific definitions, will control.

As used herein, the terms “optional” or “optionally” mean that the subsequently described event or circumstance may occur or may not occur, and that the description includes instances where the event or circumstance occurs as well as instances in which it does not. For example, “optionally substituted alkyl” refers to the alkyl may be substituted as well as where the alkyl is not substituted.

As used herein, the term “selectivity” refers to the degree to which a certain process or electrode favors the formation of a particular product over other products. As will be understood by a person of ordinary skill in the art, the selectivity may be a function of process steps, parameters, and conditions (e.g., temperature, reaction times, pre-treatment steps, etc.), and/or may be the result of intrinsic properties of system components (e.g., as a result of using electrodes that are selective for the formation of oxygen). A selectivity value may refer to a proportion of the product(s) of interest compared to other product(s) produced, or may refer to the proportion of other product(s) produced compared to the product(s) of interest. A person of ordinary skill in the art will appreciate how to select suitable methods for testing, calculating, and comparing selectivity values relevant to the present disclosure. For example, in certain embodiments, the systems and methods disclosed herein involve electrodes that are selective for the conversion of chloride to chlorine over the conversion of water to oxygen and protons.

As used herein, the term “current density” refers to an amount of charge flowing per unit time (i.e., current) through a unit area (e.g., cross-sectional area). For example, current density may be expressed as current (e.g., in Amperes) flowing through a unit area (e.g., in m²) of the surface of an anode of the disclosure using the unit A/m². Those of skill in the art are familiar with means of measuring and adjusting current density in electrical circuits relevant to the present disclosure.

As used herein, the terms “semiconductive,” “electrically semiconductive,” “semiconductor,” and other grammatical variants thereof refer to any material having semiconductive properties, including, e.g., a non-zero band gap between the valence band and conduction band of the material, and/or an electrical conductivity that increases as temperature increases. Such materials include, as non-limiting examples: Si, SiC, SiGe, SiGeC, Si alloys, Ge, Ge alloys, GaAs, InAs, InP. “Doped” semiconductors, comprising both n- and p-type dopants are also expressly contemplated.

As used herein, the terms “conductive,” “electrically conductive,” and other grammatical variants thereof describe any electrically conductive material, e.g., metals, which have a high electrical conductivity and low electrical resistivity and which have properties common to conductors (e.g., an electrical conductivity that decreases as temperature increases). For example, a material described herein as “conductive” may comprise a material having an electrical conductivity of about 58 MS/m (the International Annealed Copper Standard).

As used herein, the term “circuit” as used herein refers to a closed loop or pathway that allows the flow of electric charge, typically involving components like resistors, capacitors, inductors, and active devices like transistors. Circuits can be analog, digital, or a combination of both.

As used herein, the term “electrically connected” refers to a state of physical interface between conductive materials, enabling the passage of electric current with minimal resistance.

As used herein, the term “fuel cell” refers to a device which converts the chemical energy of a chemical fuel, e.g. hydrogen (H₂), directly to electrical energy, i.e., without converting the chemical energy to mechanical energy before producing the electrical energy (e.g., wherein the electrical energy is not produced by a rotating component). Examples of fuel cells contemplated with the use of this term include Proton Exchange Membrane Fuel Cells (PEMFCs) and Solid Oxide Fuel Cells (SOFCs). The important operational features of common fuel cells are known to those of ordinary skill in the art, and those of ordinary skill in the art will be able to select and configure suitable fuel cells for use in the systems and methods disclosed herein.

The phrase “a combination thereof,” as used herein with reference to a list or group (e.g., “wherein the dopant is selected from Sn, Fe, W, In, F, Si, and a combination thereof”), expressly contemplates any combination of any number of the group members. For example, in certain embodiments of the present disclosure, “a combination thereof” is used in reference to the group Sn, Fe, W, In, F, and Si. In such embodiments, the present disclosure expressly contemplates each and every combination of any two elements, any three elements, any four elements, any five elements, and all six elements of the group, e.g., the combination of Sn and Fe (two elements), and the combination of Sn, Fe, W, In, F, and Si (all six elements).

As used herein, the term “alkalinizing” and grammatical variants thereof refers to increasing the pH of a solution. For example, alkalinizing may be used to describe making a basic solution more basic, (e.g., increasing the pH of seawater).

The term “source” as used herein in connection with a solution (e.g., a catholyte source or an anolyte source) refers to a quantity of the solution itself (i.e., to be used as-is in the systems and methods of the disclosure), or to a composition from which the solution may be obtained. One of ordinary skill in the art will understand that a quantity of the solution may be purified, concentrated, or otherwise pre-treated before use. For example, a catholyte source of the disclosure may be a sea, ocean, or other body of water from which the catholyte (e.g., seawater) may be obtained, and the seawater may be pre-treated before use (e.g., by filtering the seawater to remove solids).

### EXAMPLES

The invention now being generally described, it will be more readily understood by reference to the following examples which are included merely for purposes of illustration of certain aspects and embodiments of the present invention, and are not intended to limit the invention.

### Example 1: Internal Recycling of Gases within the Electrolyzer

An electrolyzer was designed with separate compartments for hydrogen and chlorine production, equipped with semi-permeable membranes to prevent gas mixing while allowing ion flow.

During the experiment gas collection vessels were installed at both the cathode and anode compartments to capture hydrogen and chlorine gases, respectively. These separators were connected to a gas recycling system equipped with compressors and safety check valves to regulate pressure and prevent backflow. A control system was implemented to monitor gas pressures and concentrations. This system was fine-tuned to adjust the flow rates of recycled gases back into the electrolyzer, controlling desired mixing ratios and maintaining safety thresholds.

The recycled hydrogen gas was routed back to the cathode, participating in reducing protons to form new hydrogen gas. Similarly, the recycled chlorine gas was effectively routed back to the anode to facilitate the re-formation of chloride ions from chlorine.

The system's voltage and efficiency were continuously monitored, resulting in a cell potential between 1.5 and 2 V.

### Example 2: External Energy Recovery Using a Fuel Cell System

A suitable fuel cell type was selected that could operate with hydrogen as the fuel and chlorine as the oxidizing agent specifically adapted to solid oxide fuel cells (SOFCs) and modified proton-exchange membrane fuel cells (PEMFCs). Carbon-based electrodes cannot be used due to the instability with chlorine gas.

Gas purification units were installed to remove moisture and impurities from the collected hydrogen and chlorine gases, ensuring they met the purity requirements of the fuel cell. A regulated supply system was set up to feed these gases into the fuel cell at controlled rates.

The output of the gas collection system was directly connected to the input of the fuel cell's gas supply system. Operation between the systems was ensured with automated controls for gas flow and shutdown procedures in case of malfunctions.

The electricity generated by the fuel cell was utilized to charge a battery, which could then be used to power the electrolyzer or other components of the system or fed back into the grid. The efficiency of the fuel cell and the overall energy recovery rate were continuously monitored to assess performance improvements.

The fuel cell configurations described herein are provided as non-limiting examples of hydrogen energy recovery. Hydrogen generated by the electrochemical cell may additionally or alternatively be supplied to combustion systems, engines, turbines, boilers, or hybrid energy systems for conversion to electrical and/or thermal energy.

### INCORPORATION BY REFERENCE

All publications and patents mentioned herein are hereby incorporated by reference in their entirety as if each individual publication or patent was specifically and individually indicated to be incorporated by reference. In case of conflict, the present application, including any definitions herein, will control.

### EQUIVALENTS

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

We claim:

1. A system for alkalinizing an aqueous solution comprising:
an electrochemical cell comprising:
a cathodic chamber comprising:
a cathode;
a catholyte feed inlet;
a cathodic gas outlet; and
a cathode product outlet;
an anodic chamber comprising:
an anode;
an anolyte feed inlet;
an anodic gas outlet; and
an anode product outlet; and
a separator membrane disposed between the cathodic chamber and the anodic chamber;
wherein the cathodic chamber and the anodic chamber are in ionic communication; and
further wherein:
the cathodic chamber comprises a cathodic gas inlet coupled to the cathodic gas outlet; or
the anodic chamber comprises an anodic gas inlet coupled to the anodic gas outlet; or
the cathodic chamber comprises a cathodic gas inlet coupled to the cathodic gas outlet and the anodic chamber comprises an anodic gas inlet coupled to the anodic gas outlet

2. The system of claim 1, wherein the cathodic chamber comprises a cathodic gas inlet coupled to the cathodic gas outlet.

3. The system of claim 1 or 2, wherein the anodic chamber comprises an anodic gas inlet coupled to the anodic gas outlet.

4. The system of any one of claims 1-3, wherein:
the cathodic chamber comprises a cathodic gas inlet coupled to the cathodic gas outlet; and
the anodic chamber further comprises an anodic gas inlet, and the anodic gas outlet is coupled to the anodic gas inlet.

5. The system of any one of claims 1-4, wherein the cathodic chamber further comprises a carbon dioxide inlet.

6. The system of any one of claims 1-4, wherein the system further comprises a carbonation chamber comprising:
a carbon dioxide inlet;
an alkalinized product inlet coupled to the alkalinized product outlet; and
a carbonated product outlet; and
wherein the cathodic chamber is configured to capture carbon dioxide from a fluid comprising carbon dioxide.

7. The system of claim 6, wherein the fluid is a gas.

8. The system of claim 6, wherein the fluid is a liquid.

9. The system of any one of claims 1-8, wherein the system further comprises an anodic gas separator coupled to the anodic gas outlet.

10. The system of any one of claims 1-9, wherein the system further comprises a cathodic gas separator coupled to the cathodic gas outlet.

11. The system of any one of claims 1-10, wherein the system further comprises a cathodic gas recycling system, comprising:
a cathodic gas recycling inlet coupled to the cathodic gas outlet of the cathodic chamber;
a cathodic gas recycling outlet coupled to the cathodic gas inlet of the cathodic chamber; and
a compressor configured to increase a pressure of a fluid; and
wherein the cathodic gas recycling system is configured to transfer a cathodic gas from the cathodic gas outlet to the cathodic gas inlet.

12. The system of any one of claims 1-11, wherein the system further comprises an anodic gas recycling system, comprising:
an anodic gas recycling inlet coupled to the cathodic gas outlet of the anodic chamber;
an anodic gas recycling outlet coupled to the anodic gas inlet of the anodic chamber; and
a compressor configured to increase a pressure of a gaseous fluid; and
wherein the anodic gas recycling system is configured to transfer an anodic gas from the anodic gas outlet to the anodic gas inlet.

13. The system of any one of claims 1-12, wherein the system further comprises a combined gas recycling system comprising:
a cathodic gas recycling system, comprising:
a cathodic gas recycling inlet coupled to the cathodic gas outlet of the cathodic chamber;
a cathodic gas recycling outlet coupled to the cathodic gas inlet of the cathodic chamber; and
a compressor configured to increase a pressure of a fluid; and
wherein the cathodic gas recycling system is configured to transfer a cathodic gas from the cathodic gas outlet to the cathodic gas inlet; and
an anodic gas recycling system, comprising:
an anodic gas recycling inlet coupled to the cathodic gas outlet of the anodic chamber;
an anodic gas recycling outlet coupled to the anodic gas inlet of the anodic chamber; and
a compressor configured to increase a pressure of a gaseous fluid; and
wherein the anodic gas recycling system is configured to transfer an anodic gas from the anodic gas outlet to the anodic gas inlet.

14. The system of any one of claims 1-13, wherein the anode is configured to convert chloride to chlorine.

15. The system of any one of claims 1-14, wherein when a voltage is applied to the anode and the anode is contacted with an aqueous solution comprising chloride, Cl₂ and H⁺ and/or H₃O⁺ ions are produced selectively at the anode.

16. The system of any one of claims 1-15, wherein the cathode is configured to convert water to hydroxide ions and hydrogen.

17. The system of any one of claims 1-16, wherein the cathode is configured to convert protons to hydrogen.

18. The system of any one of claims 1-17, wherein when a voltage is applied to the cathode and the cathode is contacted with water, H₂ and OH ions are produced selectively at the cathode.

19. The system of any one of claims 1-18, wherein the cathodic gas recycling inlet and the anodic gas recycling inlet comprise backflow prevention valves (e.g., backflow preventers or gas non-return valves).

20. The system of any one of claims 1-19, wherein the electrochemical cell is configured to operate at an electrical potential of less than about 2.8 V at a current density of about 300 A/m².

21. The system of any one of claims 1-20, wherein the electrochemical cell is configured to operate at an electrical potential of less than about 2.5 V at a current density of about 300 A/m².

22. The system of any one of claims 1-21, wherein the electrochemical cell is configured to operate at an electrical potential of less than about 2.0 V at a current density of about 300 A/m².

23. The system of any one of claims 1-22, wherein the electrochemical cell is configured to operate at an electrical potential of from about 1.5 V to about 2 V at a current density of about 300 A/m².

24. The system of any one of claims 1-23, wherein the system comprises a plurality of electrochemical cells (e.g., in a unit cell arrangement).

25. The system of any one of claims 1-24, wherein the plurality of electrochemical cells is arranged in a stack (e.g., a stacked unit cell).

26. The system of claim 24 or 25, wherein an electrochemical unit cell is configured to operate at an electrical potential of less than about 2.8 V at a current density of about 300 A/m².

27. The system of any one of claims 24-26, wherein an electrochemical cell unit is configured to operate at an electrical potential of less than about 2.5 V at a current density of about 300 A/m².

28. The system of any one of claims 24-27, wherein an electrochemical unit cell is configured to operate at an electrical potential of less than about 2.0 V at a current density of about 300 A/m².

29. The system of any one of claims 24-28, wherein an electrochemical unit cell is configured to operate at an electrical potential of from about 1.5 V to about 2 V at a current density of about 300 A/m².

30. The system of any one of claims 24-29, wherein an electrochemical unit cell is configured to operate at a current density from about 10 A/m² to about 10,000 A/m².

31. The system of any one of claims 24-30, wherein an electrochemical unit cell is configured to operate at a current density from about 100 A/m² to about 1,000 A/m².

32. A system comprising:
an electrochemical cell comprising:
a first cathodic chamber comprising:
a first cathode;
a catholyte feed inlet;
a cathodic gas outlet;
a first cathode product outlet;
a first anodic chamber comprising:
a first anode;
an anolyte feed inlet;
an anodic gas outlet;
a first anode product outlet; and
a separator membrane disposed between the first cathodic chamber and the first anodic chamber; and
a fuel cell comprising:
a second cathodic chamber comprising:
a second cathode
an oxidant inlet coupled to the anodic gas outlet of the first anodic chamber;
a second cathode product outlet;
a second anodic chamber comprising:
a second anode;
a fuel inlet coupled to the cathodic gas outlet of the first cathodic chamber;
a second anode product outlet; and
an electrolyte material disposed between and in contact with the second cathode and the second anode;
wherein:
the cathodic gas outlet is coupled to the cathodic gas inlet;
the anodic gas outlet is coupled to the anodic gas inlet;
the second anode and second cathode are electrically connected; and
the second cathodic chamber and the second anodic chamber are in ionic communication

33. The system of claim 32, wherein the second anode and second cathode are electrically connected to a battery.

34. The system of claim 32 or 33, wherein the second anode and second cathode are electrically connected to a municipal power grid.

35. The system of any one of claims 32-34, wherein the first anode is configured to convert chloride to chlorine.

36. The system of any one of claims 32-35, wherein when a voltage is applied to the first anode and the first anode is contacted with an aqueous solution comprising chloride, Cl₂ and H⁺ and/or H₃O⁺ ions are produced selectively at the first anode.

37. The system of any one of claims 32-36, wherein the first cathode is configured to convert water to hydroxide ions and hydrogen.

38. The system of any one of claims 32-37, wherein the second anode is configured to convert hydrogen (H₂) to protons (H⁺) and electrons.

39. The system of any one of claims 32-38, wherein the fuel cell is configured to use hydrogen as a fuel and chlorine as an oxidant.

40. The system of any one of claims 32-39, wherein the fuel cell is a solid oxide fuel cell (SOFC).

41. The system of any one of claims 32-40, wherein the electrolyte material comprises a metal oxide, a ceramic, a ceramic-metal composite (cermet), or a combination thereof.

42. The system of any one of claims 32-41, wherein the electrolyte material comprises a metal oxide.

43. The system of any one of claims 32-42, wherein the electrolyte material comprises a ceramic material.

44. The system of any one of claims 32-43, wherein the electrolyte material comprises a ceramic-metal composite (Cermet) material.

45. The system of any one of claims 32-39, wherein the fuel cell is a proton exchange membrane fuel cell (PEMFC).

46. The system of any one of claims 32-39 and 45, wherein the electrolyte material comprises a membrane.

47. The system of claim 46, wherein the membrane is a proton exchange membrane.

48. The system of claim 46 or 47, wherein the membrane is configured to allow the passage of H⁺ ions from the second cathode to the second anode.

49. The system of any one of claims 1-48, wherein the separator membrane comprises an anion exchange membrane.

50. The system of any one of claims 1-49, wherein the separator membrane comprises a cation exchange membrane.

51. The system of any one of claims 1-50, wherein the separator membrane is a bipolar membrane.

52. The system of any one of claims 1-51, wherein the separator membrane is configured to allow flow of ions and not allow flow of gases and electrons between the first anodic chamber and first cathodic chamber.

53. The system of any one of claims 1-52, wherein the catholyte feed inlet is coupled to a catholyte source.

54. The system of any one of claims 1-52, wherein the anolyte feed inlet is coupled to an anolyte source.

55. The system of claim 54, wherein the catholyte source is the anolyte source.

56. The system of any one of claims 32-55, wherein the system comprises a plurality of electrochemical cells (e.g., in a unit cell arrangement).

57. The system of any one of claims 32-56, wherein the plurality of electrochemical cells is arranged in a stack (e.g., a stacked unit cell).

58. A method of alkalinizing aqueous solutions using the system of one of claims 1-31, wherein the method comprises:
contacting the catholyte feed inlet with a catholyte feed comprising water;
contacting the anolyte feed inlet with an anolyte feed comprising chloride; and
applying a voltage across the anode and the cathode, thereby converting chloride to chlorine in the anodic chamber and converting water to hydrogen and hydroxide in the cathodic chamber.

59. A method of alkalinizing aqueous solutions using the system of one of claims 33-57, wherein the method comprises:
contacting the catholyte feed inlet with a catholyte feed comprising water;
contacting the anolyte feed inlet with an anolyte feed comprising chloride; and
applying a voltage across the anode and the cathode, thereby converting chloride to chlorine in the first anodic chamber and converting water to hydrogen and hydroxide in the first cathodic chamber.

60. A method of alkalinizing aqueous solutions comprising:
contacting:
a catholyte feed inlet of an electrochemical cell with a catholyte feed comprising water; and
an anolyte feed inlet of the electrochemical cell with an anolyte feed comprising chloride;
wherein the electrochemical cell comprises:
a cathodic chamber comprising:
a cathode;
the catholyte feed inlet;
a cathodic gas outlet; and
a cathode product outlet;
an anodic chamber comprising:
an anode;
the anolyte feed inlet;
an anodic gas outlet; and
an anode product outlet; and
a separator membrane disposed between the cathodic chamber and the anodic chamber;
wherein:
the cathodic chamber and the anodic chamber are in ionic communication; and
further wherein:
the cathodic chamber comprises a cathodic gas inlet coupled to the cathodic gas outlet; or
the anodic chamber comprises an anodic gas inlet coupled to the anodic gas outlet; or
the cathodic chamber comprises a cathodic gas inlet coupled to the cathodic gas outlet and the anodic chamber comprises an anodic gas inlet coupled to the anodic gas outlet; applying a voltage across the anode and the cathode, thereby converting chloride to chlorine in the anodic chamber and converting water to hydrogen and hydroxide in the cathodic chamber.

61. The method of claim 60, wherein the cathodic chamber comprises a cathodic gas inlet coupled to the cathodic gas outlet.

62. The method of claim 60 or 61, wherein the anodic chamber comprises an anodic gas inlet coupled to the anodic gas outlet.

63. The method of any one of claims 60-62, wherein the cathodic chamber comprises a cathodic gas inlet coupled to the cathodic gas outlet and the anodic chamber further comprises an anodic gas inlet, and the anodic gas outlet is coupled to the anodic gas inlet.

64. The method of any one of claims 60-63, wherein the anodic chamber comprises an anodic gas inlet coupled to the anodic gas outlet and the method further comprises transferring the chlorine from the anodic gas outlet to the anodic gas inlet.

65. The method of claim 64, wherein transferring the chlorine from the anodic gas outlet to the anodic gas inlet further comprises purifying the chlorine.

66. The method of any one of claims 60-65, further comprising converting chlorine to chloride in the anodic chamber.

67. The method of any one of claims 60-66, wherein the cathodic chamber comprises a cathodic gas inlet coupled to the cathodic gas outlet, and the method further comprises transferring hydrogen from the cathodic gas outlet to the cathodic gas inlet.

68. The method of claim 67, wherein transferring the hydrogen from the cathodic gas outlet to the cathodic gas inlet further comprises purifying the hydrogen.

69. The method of any one of claims 60-68, further comprising converting hydrogen to protons in the cathodic chamber.

70. The method of any one of claims 60-69, wherein the method further comprises contacting carbon dioxide with the hydroxide, thereby generating a carbonation product comprising carbonate, bicarbonate, or a combination thereof.

71. The method of claim 70, wherein contacting carbon dioxide with the hydroxide comprises generating carbonates.

72. The method of claim 70 or 71, wherein contacting carbon dioxide with the hydroxide comprises generating bicarbonates.

73. The method of any one of claims 70-72, wherein contacting carbon dioxide with the hydroxide generates carbonates and bicarbonates.

74. The method of any one of claims 70-73, wherein the carbonation product further comprises magnesium, calcium, or a combination thereof.

75. The method of any one of claims 60-74, wherein the anode is configured to convert chloride to chlorine.

76. The method of any one of claims 60-75, wherein when the voltage is applied to the anode and the anode is contacted with an aqueous solution comprising chloride, Cl₂ and H⁺ and/or H₃O⁺ ions are produced selectively at the anode.

77. The method of any one of claims 60-76, wherein the cathode is configured to convert water to hydroxide ions and hydrogen.

78. The method of any one of claims 60-77, wherein the cathode is configured to convert protons to hydrogen.

79. The method of claim 60-78, wherein the hydrogen generated at the cathode is recovered and supplied to an external energy utilization system.

80. The method of claim 60-79, wherein the hydrogen generated at the cathode is recovered and supplied to an external energy utilization system in a separate step from any utilization, recycling, or conversion of chlorine generated during the method.

81. The method of claim 60-80, wherein the hydrogen generated at the cathode is recovered and supplied to an external energy utilization system in a separate step from any utilization, recycling, or conversion of chlorine generated at the anode.

82. The method of any one of claims 60-81, wherein when the voltage is applied to the cathode and the cathode is contacted with water, H₂ and OH ions are produced selectively at the cathode.

83. The method of any one of claims 60-82, wherein the voltage is less than about 2.8 V at a current density of about 300 A/m².

84. The method of any one of claims 60-83, wherein the voltage is less than about 2.5 V at a current density of about 300 A/m².

85. The method of any one of claims 60-84, wherein the voltage is less than about 2.0 V at a current density of about 300 A/m².

86. The method of any one of claims 60-85, wherein the voltage is from about 1.5 V to about 2 V at a current density of about 300 A/m².

87. The method of any one of claims 60-86, wherein the system comprises a plurality of electrochemical cells (e.g., in a unit cell arrangement).

88. The method of any one of claims 60-87, wherein the plurality of electrochemical cells is arranged in a stack (e.g., a stacked unit cell).

89. The method of claim 87 or 88, wherein an electrochemical unit cell is configured to operate at an electrical potential of less than about 2.8 V at a current density of about 300 A/m².

90. The method of any one of claims 87-89, wherein an electrochemical cell unit is configured to operate at an electrical potential of less than about 2.5 V at a current density of about 300 A/m².

91. The method of any one of claims 87-90, wherein an electrochemical unit cell is configured to operate at an electrical potential of less than about 2.0 V at a current density of about 300 A/m².

92. The method of any one of claims 87-91, wherein an electrochemical unit cell is configured to operate at an electrical potential of from about 1.5 V to about 2 V at a current density of about 300 A/m².

93. The method of any one of claims 87-92, wherein an electrochemical unit cell is configured to operate at a current density from about 10 A/m² to about 10,000 A/m².

94. The method of any one of claims 87-93, wherein an electrochemical unit cell is configured to operate at a current density from about 100 A/m² to about 1,000 A/m².

95. A method of alkalinizing aqueous solutions comprising:
contacting:
a catholyte feed inlet of an electrochemical cell with a catholyte feed comprising water; and
an anolyte feed inlet of the electrochemical cell with an anolyte feed comprising chloride;
wherein the electrochemical cell comprises:
a first cathodic chamber comprising:
a first cathode;
the catholyte feed inlet;
a cathodic gas outlet; and
a first cathode product outlet;
an anodic chamber comprising:
a first anode;
the anolyte feed inlet;
an anodic gas outlet; and
a first anode product outlet; and
a first membrane disposed between the first cathodic chamber and the first anodic chamber;
wherein the first cathodic chamber and the first anodic chamber are in ionic communication;
applying a voltage across the first anode and the first cathode, thereby converting chloride to chlorine in the first anodic chamber and converting water to hydrogen and hydroxide in the first cathodic chamber;
transferring the chlorine to an oxidant inlet of a fuel cell and the hydrogen to a fuel inlet of the fuel cell;
wherein the fuel cell further comprises:
a second cathodic chamber comprising:
a second cathode
an oxidant inlet coupled to the anodic gas outlet of the first anodic chamber;
a second cathode product outlet;
a second anodic chamber comprising:
the second anode;
a fuel inlet coupled to the cathodic gas outlet of the first cathodic chamber;
a second anode product outlet; and
an electrolyte material disposed between and in contact with the second cathode and the second anode;
and wherein the second anode and second cathode are electrically connected through a circuit, and the second cathodic chamber and the second anodic chamber are in ionic communication; and
converting the hydrogen to protons (H⁺) and electrons and converting chlorine to chloride, thereby generating an electric current from the second anode to the second cathode.

96. The method of claim 95, wherein the method further comprises contacting carbon dioxide with the hydroxide, thereby generating a carbonation product comprising carbonate, bicarbonate, or a combination thereof.

97. The method of claim 96, wherein contacting carbon dioxide with the hydroxide comprises generating carbonates.

98. The method of claim 96 or 97, wherein contacting carbon dioxide with the hydroxide comprises generating bicarbonates.

99. The method of any one of claims 96-98, wherein contacting carbon dioxide with the hydroxide generates carbonates and bicarbonates.

100. The method of any one of claims 96-99, wherein the carbonation product further comprises magnesium, calcium, or a combination thereof.

101. The method of any one of claims 95-100, wherein when the voltage is applied to the first anode and the first anode is contacted with an aqueous solution comprising chloride, Cl₂ and H⁺ and/or H₃O⁺ ions are produced selectively at the first anode.

102. The method of any one of claims 95-101, wherein the anode is selective for chlorine evolution reactions over oxygen evolution reactions.

103. The method of any one of claims 95-102, wherein the cathode is configured to convert water to hydroxide ions and hydrogen.

104. The method of any one of claims 95-103, wherein the cathode is configured to convert protons to hydrogen.

105. The method of any one of claims 95-104, wherein when the voltage is applied to the first cathode and the first cathode is contacted with water, H₂ and OH ions are produced selectively at the first cathode.

106. The method of any one of claims 95-105, wherein the second anode is configured to convert hydrogen (H₂) to protons (H⁺) and electrons.

107. The method of any one of claims 95-106, wherein the fuel cell is configured to consume hydrogen and chlorine (e.g., hydrogen as a fuel and chlorine as an oxidant).

108. The method of any one of claims 95-107, wherein the fuel cell is a solid oxide fuel cell (SOFC).

109. The method of any one of claims 95-108, wherein the electrolyte material comprises a metal oxide, a ceramic, a ceramic-metal composite (cermet), or a combination thereof.

110. The method of any one of claims 95-109, wherein the electrolyte material comprises a metal oxide.

111. The method of any one of claims 95-110, wherein the electrolyte material comprises a ceramic material.

112. The method of any one of claims 95-111, wherein the electrolyte material comprises a ceramic-metal composite (Cermet) material.

113. The method of any one of claims 95-107, wherein the fuel cell is a proton exchange membrane fuel cell (PEMFC).

114. The method of any one of claims 95-107 and 113, wherein the electrolyte material comprises a second membrane.

115. The method of claim 114, wherein the second membrane is a proton exchange membrane.

116. The system of claim 114 or 115, wherein the second membrane is configured to allow the passage of H⁺ ions from the second cathode to the second anode.

117. The method of any one of claims 95-116, wherein the first membrane comprises an anion exchange membrane.

118. The method of any one of claims 95-117, wherein the first membrane comprises a cation exchange membrane.

119. The method of any one of claims 95-118, wherein the first membrane is a bipolar membrane.

120. The method of any one of claims 95-119, wherein the first membrane is configured to allow flow of ions and not allow flow of gases and electrons between the first anodic chamber and first cathodic chamber.

121. The method of claim 95-120, wherein the hydrogen generated at the cathode is recovered and supplied to an external energy utilization system.

122. The method of claim 95-121, wherein the hydrogen generated at the cathode is recovered and supplied to an external energy utilization system in a separate step from any utilization, recycling, or conversion of chlorine generated during the method.

123. The method of any one of claims 95-122, wherein the hydrogen generated at any one of the first cathode or second cathode is recovered and supplied to an external energy utilization system in a separate step from any utilization, recycling, or conversion of chlorine generated at the first anode or second anode.

124. The method of any one of claims 95-123, wherein the system comprises a plurality of electrochemical cells (e.g., in a unit cell arrangement).

125. The method of any one of claims 95-134, wherein the plurality of electrochemical cells is arranged in a stack (e.g., a stacked unit cell).

126. The method of any one of claims 60-94, performed using the system of any one of claims 1-31.

127. The method of any one of claims 95-125, performed using the system of any one of claims 32-57.
